(19) United States
(12) Patent Application Publication
(10) Pub. No.: US 2012/0321445 A1
(43) Pub. Date: Dec. 20, 2012

(54) AUTOMATIC SWING MECHANISM

(75) Inventors: Huasong Zhou, Xiamen (CN); Shuiyuan Luo, Xiamen (CN); Jianmin Chen, Xiamen (CN); Bin Chen, Xiamen (CN)

(73) Assignee: XIAMEN SOLEX HIGH- TECH INDUSTRIES CO., LTD., Xiamen, Fujian (CN)

(21) Appl. No.: 13/519,373

(22) PCT Filed: Jan. 11, 2011
(86) PCT No.: PCT/CN2011/070161

§ 371 Date: Jun. 27, 2012

(30) Foreign Application Priority Data
Jan. 15, 2010 (CN) 20101005527.5
Jan. 15, 2010 (CN) 201020004369.7

(51) Int. Cl. A47K 3/00; F03B 3/00; F03B 13/00; F01D 15/12

(52) U.S. Cl. 415/122.1

(57) ABSTRACT

An automatic swing mechanism has: a base, a lifting rod that can swing relative to the base and a driving mechanism that connects the base and the lifting rod, a flow passage that the flow can pass through is arranged in the base, and the driving mechanism comprises an impeller and a transmission mechanism. The impeller is pivotally arranged in the flow passage and can be rotated by the water passing through the flow passage. The transmission mechanism is connected between the impeller and the lifting rod to transform the rotation of the impeller to the swing of the lifting rod. The automatic swing mechanism drives the lifting rod swing by using the power of water, and the stuff arranged in the lifting rod can swing, such as handheld shower.

### FIELD OF THE INVENTION

The present invention relates to shower equipment, and more particular to an automatic swing mechanism in the shower equipment.

### BACKGROUND OF THE INVENTION

The mechanism is usually presented in the shower equipment at the prior art, such as in the American shower equipment: it comprises a upper wall seat, a lower wall seat, a lifting rod fixed between the upper wall seat and the lower wall seat and a sliding seat that liftingly connected on the lifting rod and in which a handheld shower is placed. The handheld shower placed in the sliding seat is fixed for the fixing of the lifting rod.

### SUMMARY OF THE INVENTION

The object of the present invention is to offer an automatic swing mechanism, which solves the immobility problem of the lifting rod at the prior art.

The technical proposal to solve the technical matters in the present invention is:

An automatic swing mechanism, it comprises: a base, a lifting rod that can swing relative to the base and a driving mechanism that connects the base and the lifting rod, a flow passage that the flow can pass through is arranged in the base, and the driving mechanism comprises:

An impeller, which is pivotally arranged in the flow passage and can be rotated by the water passing through the flow passage,

And a transmission mechanism, which is connected between the impeller and the lifting rod and is used for transforming the rotation of the impeller to the swing of the lifting rod.

In a preferred embodiment, the transmission mechanism comprises:

A crank and rocker mechanism, which comprises a fixing rod that is rotationally connected to the base, a rocker that is fixed to the external revolution surface of the fixing rod, and a low speed gear that is rotationally connected to the base, an eccentric shaft is fixedly arranged on the low speed gear, and the eccentric shaft is slidingly connected to the rocker;

And a deceleration system, which is connected between the low speed gear and the impeller.

In a preferred embodiment, a connecting shaft is fixedly arranged on the impeller and an eccentric wheel is fixed to the end of the connecting shaft;

The deceleration system comprises a differential gear that is fixed in the base and a high speed gear that is synchronously and rotationally connected to the eccentric wheel, the high speed gear is meshed to the differential gear and drivingly connected to the low speed gear.

In a preferred embodiment, the high speed gear comprises a large gear and a pinion that is concentrically fixed to the large gear; the large gear is meshed to the differential gear, and the pinion is meshed to the low speed gear.

In a preferred embodiment, a switch is arranged on the base and used for controlling the rotation of the impeller.

In a preferred embodiment, the switch is a carrier rod that is hermetically connected to the base, and the carrier rod is slidingly connected to the base and slides between the first position and the second position, the first position means that the carrier rod is far away from the impeller so that the impeller can rotate freely, the second position means that the carrier rod is against the impeller so that the rotation of the impeller is limited.

In a preferred embodiment, the impeller comprises a fixing seat and several blades that are fixed to the outside of the fixing seat, the gap is arranged on the under part of the blade.

In a preferred embodiment, the base comprises:

A engine base, which is provided with a footwall and a surrounding wall that is fixed to the footwall, the top surface of the footwall is concaved downward to form a pivot slot, the bottom surface of the footwall is concaved upward to form a sink, a water inlet running through and communicating with the sink is opened up in the surrounding wall;

An engine base gland that is hermetically mounted on the surrounding wall of the engine base;

And an outlet gland with a water outlet, which is hermetically mounted to the opening of the sink of the engine base;

The flow passage is formed by the sink and the outlet gland, and the water outlet and the water inlet are connected by the flow passage;

The lower end of the fixing rod is connected to the pivot hole of the engine base through the bearing, and the upper end passes through the engine base gland and is fixed to the lifting rod.

In a preferred embodiment, the differential gear is internal gear and is formed in one piece with the engine base, and the impeller is located between the differential gear and the outlet gland.

In a preferred embodiment, the switch is controlled by waterpower; two independent waterways are arranged in the base, and the impeller is arranged in one of the independent waterways; the flowing of the water current to which independent waterway is controlled by the switch, if the water current flows through the independent waterway in which the impeller is arranged, the impeller rotates and drives the lifting rod swing; if the water current flows through the other independent waterway, the impeller stops rotating.

Compared with the mechanism at the prior art, the benefits of the the present invention are:

1 It drives the lifting rod swing by the power of water, and the stuff arranged on the lifting rod can swing, such as handheld shower, so that the shower area is greatly enlarged, the comfort level is greatly enhanced and some massage effect is achieved. The present invention can be used in any kind of the showers and outlet terminals; the cost is decreased by no additional driving mechanism; the swinging can last during the flowing process.

2 The powerful torque and the appropriate rotation speed are gained by using differential gear train to decelerate.

3 The crank and rocker mechanism transforms the one-way rotation movement of the impeller to the reciprocating swing of the lifting rod with simple structure.

4 The users can control the swing by using a switch.

5 The switch is carrier rod, the sliding of the carrier rod control the rotation of the impeller, and then control the swing of the lifting rod, and the control structure is simple.

6 A gap is arranged on the under part of the blade, it is convenient for flowing and avoids the blocking of the waterway by the impeller.

7 The differential gear internal gear, and the differential gear and the engine base is formed in one piece, so that the structure is simple and solid with low cost.

### BRIEF DESCRIPTION OF THE DRAWINGS

With the following description of the drawings and specific embodiments, the invention shall be further described in details.

FIG. 1 shows the assembly diagram of the lifting rod.

FIG. 2 shows the exploded view of the automatic swing mechanism.

FIG. 3 shows the solid diagram of the engine base of the automatic swing mechanism.

FIG. 4 shows the top plan view of the engine base of the automatic swing mechanism.

FIG. 5 shows the first abridged general view of the transmission mechanism of the automatic swing mechanism.

FIG. 6 shows the second abridged general view of the transmission mechanism of the automatic swing mechanism.

FIG. 7 shows the third abridged general view of the transmission mechanism of the automatic swing mechanism.

FIG. 8 shows the forth abridged general view of the transmission mechanism of the automatic swing mechanism.

FIG. 9 shows the cooperation diagram of the impeller and the transmission mechanism of the automatic swing mechanism, the carrier rod is at the first position at the moment.

FIG. 10 shows the cooperation diagram of the impeller and the transmission mechanism of the automatic swing mechanism, the carrier rod is at the second position at the moment.

FIG. 11 shows the waterway diagram of the automatic swing mechanism.

FIG. 12 shows the cross-sectional view of FIG. 11 A-A.

FIG. 13 shows the partial diagrammatic cross-sectional view of the automatic swing mechanism.

### DESCRIPTION OF THE PREFERRED EMBODIMENTS

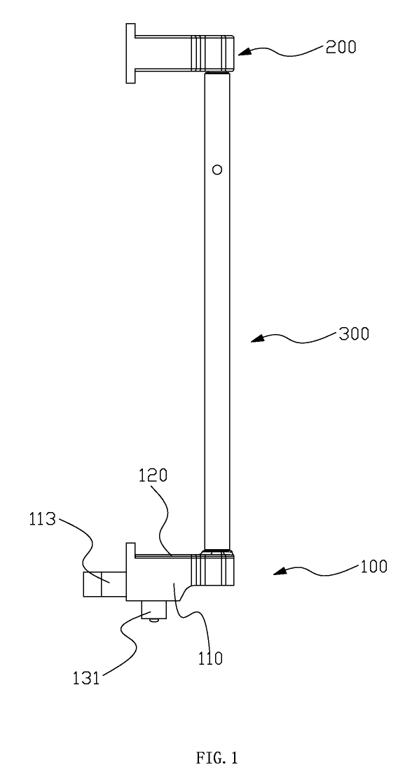

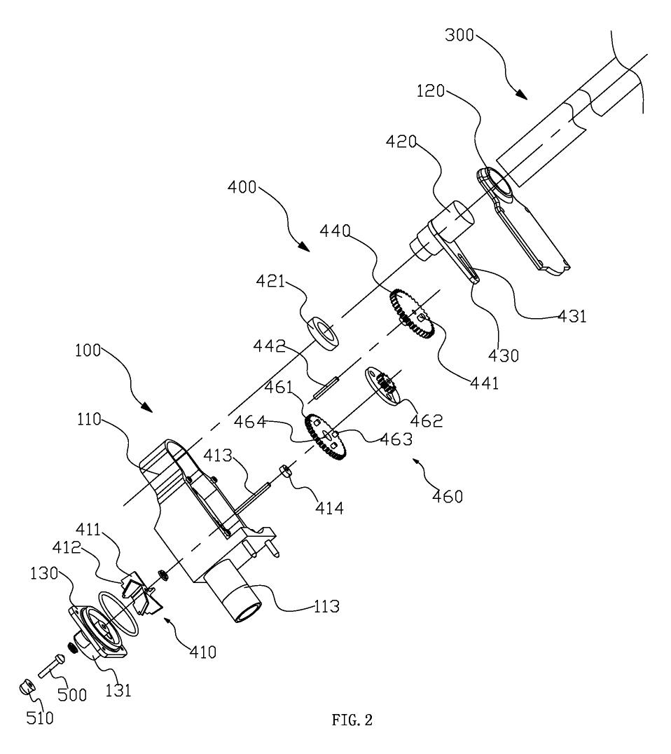

With reference of FIG. 1 and FIG. 2, the automatic swing mechanism comprises a base 100, an upper wall seat, a lifting rod 300 that can swing relative to the base 100 and the upper wall seat 200, and a driving mechanism 40 that connects the base 100 and the lifting rod 300. The base 100 and the upper wall seat are all fixed to the wall, the upper end of the lifting rod 300 is pivotally connected to the upper wall seat 200, the driving mechanism 400 that connects the lower end of the lifting rod 300 and the base 100 can drives the lifting rod 300 swing.

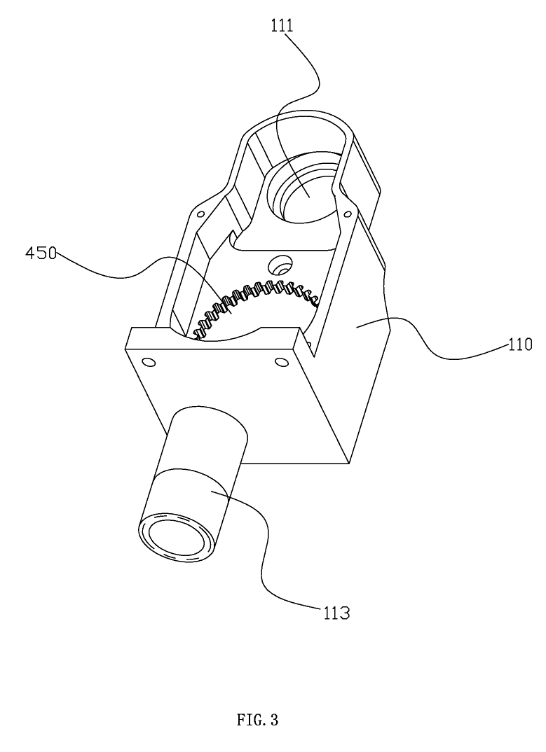

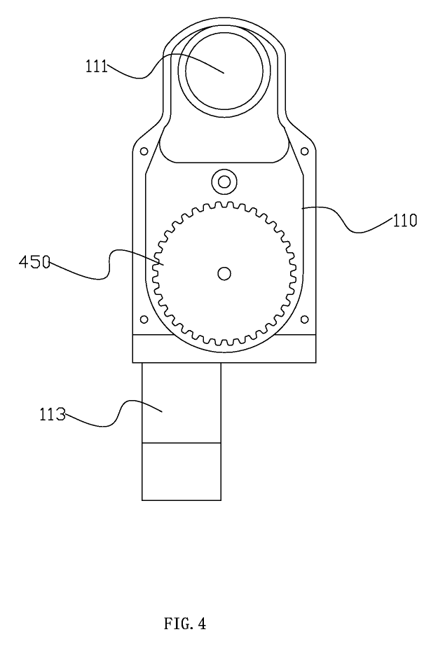

According to FIG. 2, FIG. 3 and FIG. 4, the base 100 comprises an engine base 110, an engine base gland 120, and an outlet gland 130. The engine base 110 is provided with a footwall and a surrounding wall that is fixed to the footwall, the top surface of the footwall is concaved downward to form a pivot slot 111, the bottom surface of the footwall is concaved upward to form a sink 112, a water inlet 113 that makes the sink 112 perforative and is communicated with the sink 112 is opened up in the surrounding wall; he engine base is fixed in the wall, and, the water inlet 113 is communicated with the water source buried in the wall. The water source is communicated with the water inlet 113 in the present embodiment, but without limitations, a water source that can drive the water into the sink is ok. The engine base gland 120 is hermetically mounted on the surrounding wall of the engine base 110. The outlet gland 130 is hermetically mounted to the open of the sink 112 of the engine base 110; a water outlet 131 is opened up in the outlet gland 130. A flow passage is formed by the sink 112 and the outlet gland 130, connecting the water outlet 131 and the water inlet.

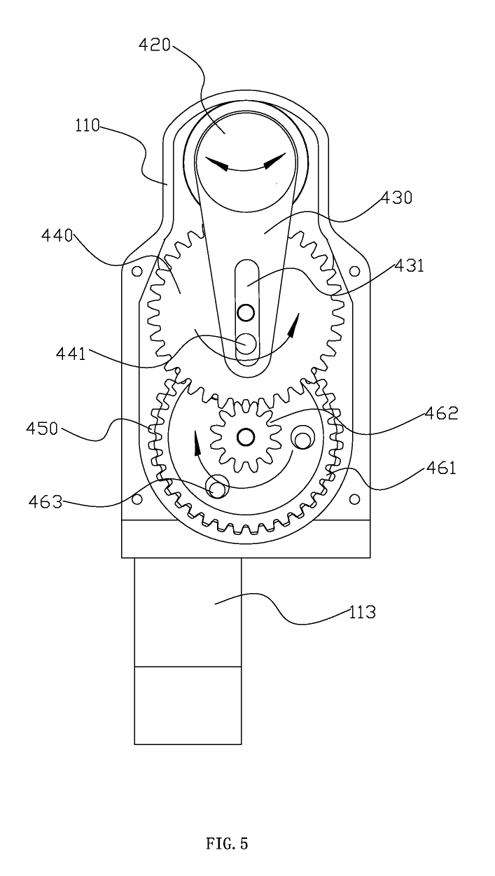

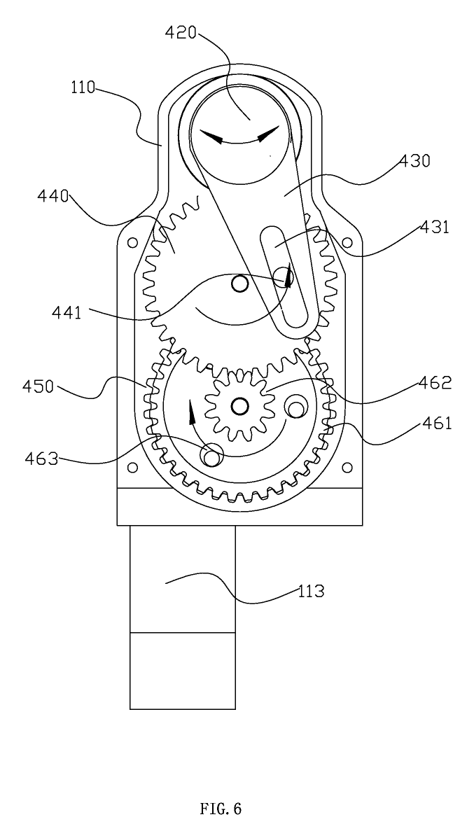

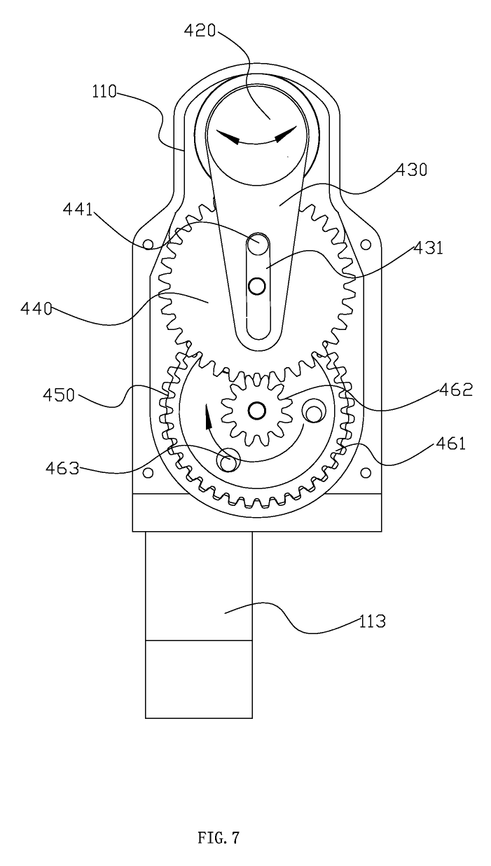

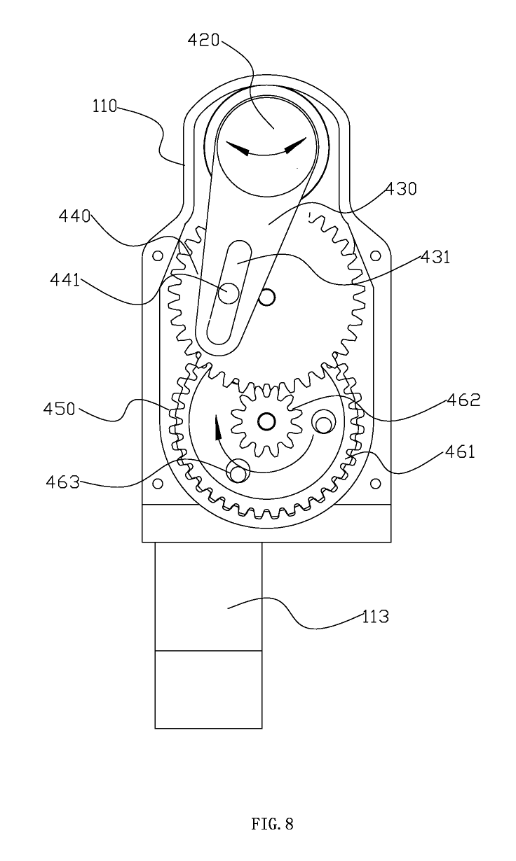

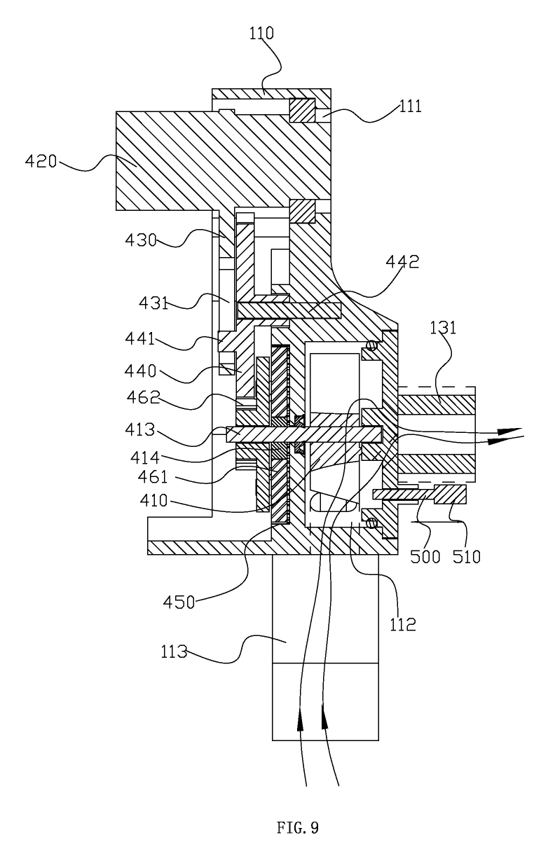

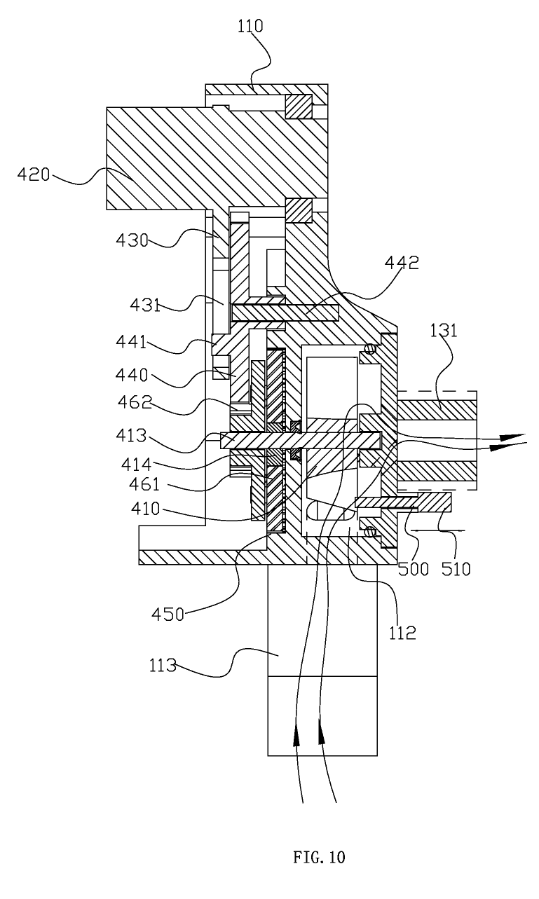

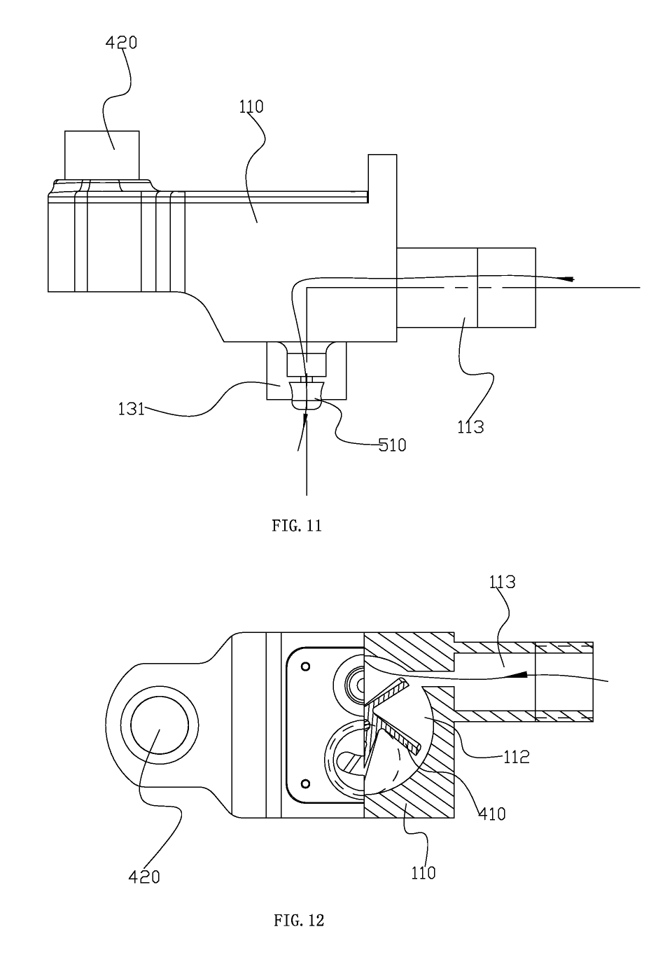

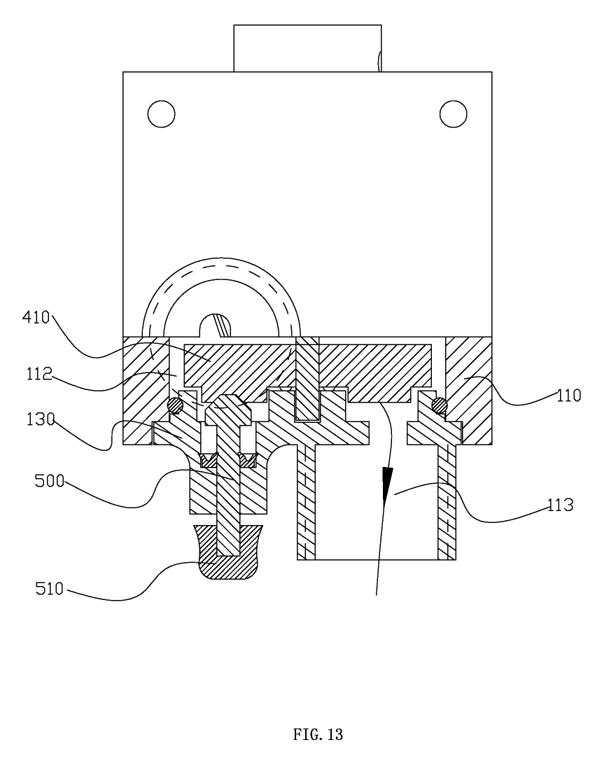

According to FIG. 2 to FIG. 13, the driving mechanism 400 comprises an impeller and a transmission mechanism.

The impeller is pivotally arranged in the sink 112 of the engine base 110 and is corresponding to the flow passage, so that the impeller 410 is rotated by the water flowing through the flow passage. The impeller 410 comprises a fixing seat and several blades 411 that are fixed to the outside of the fixing seat, the gap 412 is arranged on the under part of the blade 411. And a connecting shaft 413 and an eccentric wheel 414 are cooperated with the impeller. The connecting shaft 413 is fixedly passed through the impeller 410 and is provided with upper extended part and a lower extended part which are extended above the fixing seat, the lower extended part is pivotally connected to the outlet gland 130, the upper extended part passes through the footwall of the engine seat 110 hermetically and rotationally and is extended from the footwall upwards, the eccentric wheel 414 is fixedly connected to the part of the connecting shaft 413 which is above the footwall.

The transmission mechanism that is connected between the impeller 410 and the lifting rod 300 and is used for transforming the rotation of the impeller 410 to the swing of the lifting rod comprises a fixing rod 420, a rocker 430, a low speed gear 440, a differential gear 450 and a high-speed gear cluster.

The lower end of the fixing rod is rotationally connected to the pivot slot 111 of the engine base 110 through the bearing 421, and the upper end passes through the engine base gland 120 hermetically and rotationally and is fixed to the lower end of the lifting rod 300, so that the fixing rod 420 can drive the lifting rod 300 rotate. The rocker 430 is fixed on the external revolution surface of the fixing rod 420 and is vertical to the axis of the fixing rod 420, and a sliding groove is opened up on the rocker 430. The low speed gear 440 is pivotally connected to the engine base 110 through the support shaft 442, and an eccentric shaft 441 is fixed on the upper end face of the lower speed gear, and the eccentric shaft 441 can be connected to the sliding groove 431 of the rocker 430. The rocker 430 and the lower speed gear 440 are cooperated with each other to form a crank and rocker mechanism used for transforming the rotation of the lower speed gear 440 to the small angle swing of the rocker 430.

The differential gear 450 is internal gear, and is fixed on the footwall of the engine base 110, and the differential gear 450 and the engine base 110 is formed in one piece in the present embodiment. The high-speed gear cluster 460 comprises a large gear 461, a pinion 462 that is concentrically fixed to the large gear 461, and three support shaft 463 that are concentrically fixed to the large gear 461 and the pinion 462. A connecting groove 464 is opened up in the large gear 461 and is correspondingly connected to the eccentric wheel 414 of the impeller 410, so that the impeller 410 can drive the high-speed gear cluster 460 rotate through the connecting shaft 413 and the eccentric wheel 414. In the present embodiment, some clearance is present between the connecting groove 464 and the eccentric wheel 414, so that the eccentric wheel 414 can slide relative to the high-speed gear cluster 460 and make the assembly easy. The high-speed gear cluster 460 is meshed to the differential gear 450, and in the present embodiment, the gear teeth of the differential gear 450 is adaptive to the gear teeth of large gear of the high-speed gear cluster 460, and the number of the gear teeth of the differential gear 450 is larger than the number of the gear teeth of large gear of the high-speed gear cluster 460, and is one more; and when the eccentric wheel makes a round, the high-speed gear turn a tooth relative to the engine base, so that big transmission ratio is gained. In the present embodiment, the differential gear and the high speed gear are cooperated with each other to form differential gear train deceleration system.

The low speed gear 440 is meshed with the pinion of the high-speed gear cluster.

In the present embodiment, a switch is arranged on the base 100 to control the rotation of the impeller 410. The switch is a carrier rod 500 that passes through the outlet gland 130 of the base 100 hermetically and slidingly, and the carrier rod is slidingly connected to the outlet gland 130 and slides between the first position and the second position, the first position means that the carrier rod 500 is far away from the impeller 410 so that the impeller 410 can rotate freely, the second position means that the carrier rod 500 is inserted in and against the rotation-limiting groove opened up in the impeller 410 so that the rotation of the impeller 410 is limited. A handle 510 is arranged at the end of the carrier rod 500. In the present embodiment, the rotation of the impeller 410 is controlled by the carrier rod 500 so that the swing of the lifting rod is controlled, but other arrangements are not limited to achieve the same function, meaning the flow control can also be adaptive to the present embodiment. The flow control means: two independent waterways are arranged in the base 100, the impeller is arranged in one of the independent waterways, which independent waterway the water current flows in is controlled by the switch, if the water current flows through the independent waterway in which the impeller is arranged, the impeller rotates and drive the lifting rod swing; if the water current flows through another independent waterway, the impeller stops rotating.

The invention has been described with reference to the preferred embodiments mentioned above; therefore it cannot limit the reference implementation of the invention. It is obvious to a person skilled in the art that structural modification and changes can be carried out without leaving the scope of the claims hereinafter and the description above.

### INDUSTRIAL APPLICABILITY

The automatic swing mechanism in the present invention drives the lifting rod swing by using the power of water, and the stuff arranged in the lifting rod can swing, such as handheld shower, so that the shower area is greatly enlarged, the comfort level is greatly enhanced and some massage effect is achieved. The present invention can be used in any kind of the showers and outlet terminals; the cost is decreased by no additional driving mechanism; the swinging can last during the flowing process.

What is claimed is:

1. An automatic swing mechanism, wherein it comprises: a base, a lifting rod that can swing relative to the base and a driving mechanism that connects the base and the lifting rod, a flow passage that the flow can pass through is arranged in the base, and the driving mechanism comprises:
An impeller, which is pivotally arranged in the flow passage and can be rotated by the water passing through the flow passage,
And a transmission mechanism, which is connected between the impeller and the lifting rod and is used for transforming the rotation of the impeller to the swing of the lifting rod.

2. An automatic swing mechanism according to claim 1, wherein, the transmission mechanism comprises:
A crank and rocker mechanism, which comprises a fixing rod that is rotationally connected to the base, a rocker that is fixed to the external revolution surface of the fixing rod, and a low speed gear that is rotationally connected to the base, an eccentric shaft is fixedly arranged on the low speed gear, and the eccentric shaft is slidingly connected to the rocker;
And a deceleration system, which is connected between the low speed gear and the impeller.

3. An automatic swing mechanism according to claim 2, wherein, a connecting shaft is fixedly arranged on the impeller and an eccentric wheel is fixed to the end of the connecting shaft;
The deceleration system comprises a differential gear that is fixed in the base and a high speed gear that is synchronously and rotationally connected to the eccentric wheel, the high speed gear is meshed to the differential gear and drivingly connected to the low speed gear.

4. An automatic swing mechanism according to claim 3, wherein, the high speed gear comprises a large gear and a pinion that is concentrically fixed to the large gear; the large gear is meshed to the differential gear, and the pinion is meshed to the low speed gear.

5. An automatic swing mechanism according to claim 2 wherein, a switch is arranged on the base and used for controlling the rotation of the impeller.

6. An automatic swing mechanism according to claim 5, wherein, the switch is a carrier rod that is hermetically connected to the base, and the carrier rod is slidingly connected to the base and slides between the first position and the second position, the first position means that the carrier rod is far away from the impeller so that the impeller can rotate freely, the second position means that the carrier rod is against the impeller so that the rotation of the impeller is limited.

7. An automatic swing mechanism according to claim 1 wherein, the impeller comprises a fixing seat and several blades that are fixed to the outside of the fixing seat, the gap is arranged on the under part of the blade.

8. An automatic swing mechanism according to claim 3, wherein, the base comprises:
A engine base, which is provided with a footwall and a surrounding wall that is fixed to the footwall, the top surface of the footwall is concaved downward to form a pivot slot, the bottom surface of the footwall is concaved upward to form a sink, a water inlet running through and communicating with the sink is opened up in the surrounding wall;
An engine base gland that is hermetically mounted on the surrounding wall of the engine base;
And an outlet gland with a water outlet, which is hermetically mounted to the opening of the sink of the engine base;
The flow passage is formed by the sink and the outlet gland, and the water outlet and the water inlet are connected by the flow passage;
The lower end of the fixing rod is connected to the pivot hole of the engine base through the bearing, and the upper end passes through the engine base gland and is fixed to the lifting rod.

9. An automatic swing mechanism according to claim 8, wherein, the differential gear is internal gear and is formed in one piece with the engine base, and the impeller is located between the differential gear and the outlet gland.

10. An automatic swing mechanism according to claim 5, wherein, the switch is controlled by waterpower; two independent waterways are arranged in the base, and the impeller is arranged in one of the independent waterways; the flowing of the water current to which independent waterway is controlled by the switch, if the water current flows through the independent waterway in which the impeller is arranged, the impeller rotates and drives the lifting rod swing; if the water current flows through the other independent waterway, the impeller stops rotating.

11. An automatic swing mechanism according to claim 3 wherein, a switch is arranged on the base and used for controlling the rotation of the impeller.

12. An automatic swing mechanism according to claim 4 wherein, a switch is arranged on the base and used for controlling the rotation of the impeller.

13. An automatic swing mechanism according to claim 11, wherein, the switch is a carrier rod that is hermetically connected to the base, and the carrier rod is slidingly connected to the base and slides between the first position and the second position, the first position means that the carrier rod is far away from the impeller so that the impeller can rotate freely, the second position means that the carrier rod is against the impeller so that the rotation of the impeller is limited.

14. An automatic swing mechanism according to claim 12, wherein, the switch is a carrier rod that is hermetically connected to the base, and the carrier rod is slidingly connected to the base and slides between the first position and the second position, the first position means that the carrier rod is far away from the impeller so that the impeller can rotate freely, the second position means that the carrier rod is against the impeller so that the rotation of the impeller is limited.

15. An automatic swing mechanism according to claim 2 wherein, the impeller comprises a fixing seat and several blades that are fixed to the outside of the fixing seat, the gap is arranged on the under part of the blade.

16. An automatic swing mechanism according to claim 3 wherein, the impeller comprises a fixing seat and several blades that are fixed to the outside of the fixing seat, the gap is arranged on the under part of the blade.

17. An automatic swing mechanism according to claim 4 wherein, the impeller comprises a fixing seat and several blades that are fixed to the outside of the fixing seat, the gap is arranged on the under part of the blade.

18. An automatic swing mechanism according to claim 11, wherein, the switch is controlled by waterpower; two independent waterways are arranged in the base, and the impeller is arranged in one of the independent waterways; the flowing of the water current to which independent waterway is controlled by the switch, if the water current flows through the independent waterway in which the impeller is arranged, the impeller rotates and drives the lifting rod swing; if the water current flows through the other independent waterway, the impeller stops rotating.

19. An automatic swing mechanism according to claim 12, wherein, the switch is controlled by waterpower; two independent waterways are arranged in the base, and the impeller is arranged in one of the independent waterways; the flowing of the water current to which independent waterway is controlled by the switch, if the water current flows through the independent waterway in which the impeller is arranged, the impeller rotates and drives the lifting rod swing; if the water current flows through the other independent waterway, the impeller stops rotating.
